(19) United States
(12) Patent Application Publication
(10) Pub. No.: US 2003/0122330 A1
(43) Pub. Date: Jul. 3, 2003

(54) Human powered snow vehicle

(76) Inventor: Daniel W. Nelson, Rochester, MN (US)

Correspondence Address: Briggs and Morgan, P.A., 2400 IDS Center, 80 South Eighth Street, Minneapolis, MN, 55402, US

(21) Appl. No.: 10/336,606

(22) Filed: Jan. 2, 2003

Related U.S. Application Data
(60) Provisional application No. 60/345,214, filed on Jan. 2, 2002.

(51) Int. Cl. B62B 9/04

(52) U.S. Cl. 280/12.1

(57) ABSTRACT

A human powered, recumbent snowmobile is here presented. It is designed to enable its rider to cycle on packed snow and in up to several inches of unpacked snow. In an effort to minimize manufacturing costs, parts from the larger mountain bicycle and bicycle markets are used.

### BACKGROUND OF THE INVENTION

This application is a continuation of provisional patent application Ser. No. 60/345,214, filed Jan. 2, 2002.

This invention addresses the paucity of outdoor training options for cyclists and the paucity of outdoor exercise options in general during months of snow, the difficulty of bicycling in snow for those who choose to bicycle rather than travel by automobile for local travel, and the desire for environmentally friendly winter recreation and travel. This invention increases the options for those who want to enjoy the out of doors by increasing their range of travel while maintaining the sanctity of quiet and cleanliness. It may also be used for recreational sledding, in which case the user may cycle uphill instead of walking.

Human-powered snow cycles are known, as evidenced by U.S. Pat. Nos. 3,931,983; 5,423,559; and 5,102,153. However, they have not been commercially successful because of a number of problems. The '983, '559, and '153 patents are all basically modifications on a standard bicycle frame. As such, they are flimsy, lack stability, and do not have enough power to drive the vehicle over the snow. Motor-driven snow cycles are also known, as evidenced by U.S. Pat. No. 4,146,101. However, these vehicles are complex and expensive to manufacture and are not environmentally friendly. U.S. Pat. No. 6,382,338 discloses a motor-driven or human-powered snow vehicle. However, it is also complex and expensive to manufacture, and the necessities of the motor-driven embodiment necessarily make the human-driven embodiment unnecessarily complex.

The present invention discloses a human powered snowmobile that is light enough and inexpensive enough to be a practical option for use in the above scenarios as well as other scenarios. A recumbent model is here described because of its increased power (the legs push against the seat instead of lifting the body), the distribution of weight over the drive train, the constant position of the center of weight, a decrease in wind resistance, and because it allows elevation of the gear shifting and braking components to eliminate clogging by snow. To minimize manufacturing costs, as many parts as possible are already standard in the bicycle industry, allowing this product to capitalize on reduced costs from mass production for the larger bicycle industry. Another feature aimed at reducing cost is the adjustable seat (though if it proves to be impractical, then the frame may be modified to accommodate any extant or yet to be developed recumbent bicycle seat). This will allow multiple people to use a single vehicle, adjusting it to suite their different leg lengths. The adjustable seat may also allow for fewer frame sizes to accommodate a lower price market population.

### SUMMARY OF THE INVENTION

A human powered, recumbent snowmobile is here presented. It is designed to enable its rider to cycle on packed snow and in up to several inches of unpacked snow. In an effort to minimize manufacturing costs, parts from the larger mountain bicycle and bicycle markets are used.

### BRIEF DESCRIPTION OF THE DRAWINGS

FIG. 1 is a right side elevational view of the present invention.

FIG. 2 is a left side elevational view of the present invention.

FIG. 3 is a top plan view of the present invention.

FIG. 4 is a rear elevational view of the present invention (with side skis).

FIG. 5 is a front elevational view of wheel relationship to drive track.

FIG. 6 is a detailed view of a drive wheel hub.

FIG. 7 is a detailed view of a single brake upper gear and brake hub.

FIG. 8 is a detailed view of a double brake upper gear and brake hub.

FIG. 9 is a side elevational view of an alternate frame with mountain bicycle shock absorber fork.

FIG. 10 is a side elevational view of an alternate frame with standard front fork.

FIG. 11 is a side elevational view of side ski plus custom front shock absorber.

FIG. 12 is a detailed view of a simple forked front ski mount.

FIG. 13 is a detailed view of a custom shock absorber front ski mount.

FIG. 14 is a detailed view of a tracked, front ski replacement for use on roads

FIG. 15 is a detailed view of the seat.

FIG. 16 is a detailed view of the seat mounting clamp.

FIG. 17 is a side elevational view of a reverse track configuration.

FIG. 18 is a top plan view of the reverse track configuration.

FIG. 19 is a schematic of a drive track snow cover.

FIG. 20 is a detailed view of an alternative drive track crosspiece

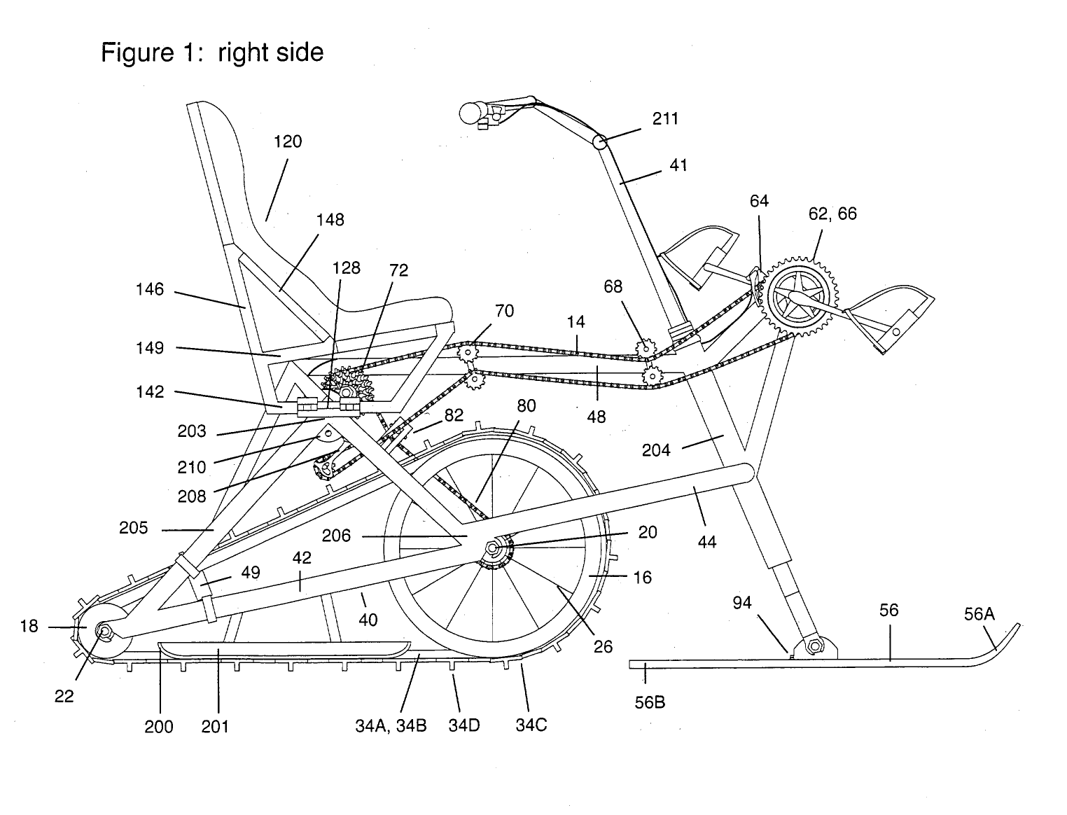

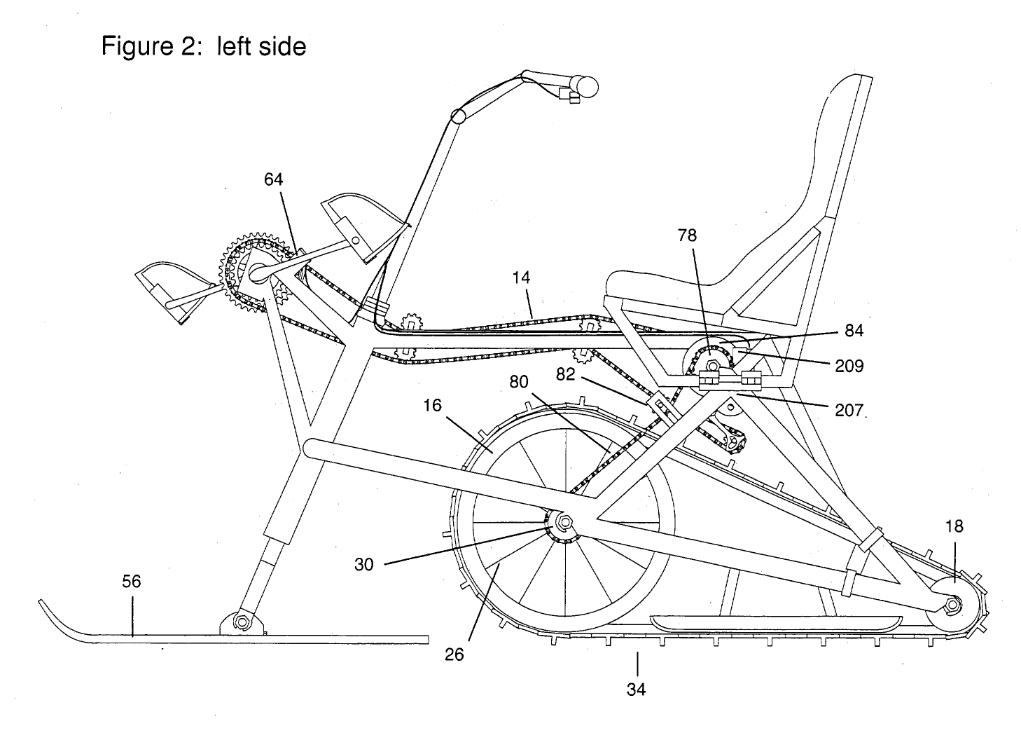

### DETAILED DESCRIPTION OF THE PREFERRED EMBODIMENT

I Axles and Wheels

The drive track (34) is a continuous loop tread that passes around wheels (16, 18) centered on a forward (20) and on a rear (22) axle. The forward wheels (16) have a larger radius than the rear wheels (18) and are responsible for transferring the pedaling and braking forces to the track loop (34). The rear wheels (18) extend the surface area of the interface between the track and the snow, distributing weight and increasing traction. A bar (201) located above the outer edge of the track (183), extending between the forward (16) and rear (18) wheels, prevents the tread from being pushed upwards between the wheels. A low friction strip (200) along the underside of this bar (201) reduces drag between the bar and the drive track (34).

The front wheel system (16) consists of two bicycle wheel rims (24) attached by spokes (26) to a single hub (28) that rotates on ball bearings around an axle (20). This hub (28) is similar to two bicycle wheel hubs fused together that rotate on ball bearings around the same axle. One side of the hub is fastened to a gear (30) so that when the gear is turned, the hub turns. The hub should be sealed against water entry.

The wheel rims (24) should be of a diameter that strikes a balance between the smallest height of the driver above the ground, the greatest traction between the rim and the drive track, the maximum power delivered by the pedaling system, and the maximum traveling speed of the vehicle.

The rear wheels (18) should be smaller than the front wheels (16). They should spin on ball bearings that are sealed against corrosion by water and salt. They are secured with an adjustable fastener (32) on the outer side and a larger diameter section of the axle (33) on the inner side. The top and bottom of these wheels when viewed head-on may be domed to allow incoming snow on the track to be driven away from the contact point between the wheel and the track. Wheels produced for the inline skate market might prove satisfactory for this purpose.

II Drive Track

The drive track (34) consists of two continuous belts (34A, 34B) that run around the front (16) and rear (18) wheels, with crosspieces (34C) perpendicular to these belts. The belts sit in the rims (24) of the front wheels (16), so that when the drive wheel hub (28) turns, the belts (34A, 34B) turn the track (34). If the material of the belts cannot be made tacky enough to prevent slippage between the rims and the belts, then any of several variations may be used, including the following: 1. secure a band of material in the wheel rim that, in combination with the belt material, affords adequate traction, 2. secure a toothed or notched band in the rim, teeth facing outwards, in combination with toothed or notched belts. The belts may consist of a single piece or of many linked pieces.

The crosspieces (34C) of the track extend out from the belts a distance equal to or greater than the width of the rear wheels. The rear wheels are positioned on the outer side of each belt loop, keeping the rear of the track from sliding sideways (the front is kept in line by passing within the wheel rims). The rear wheels roll against the inside of the crosspieces. The crosspieces may have ridges (34D, 175, 180) or any other devices that will provide adequate traction on loose and packed snow as well as adequate strength so as not to break when the vehicle is driven on pavement.

III Body Frame

The front (20) and rear (22) axles are secured by two parallel frames (40), connected at the top (203), the front steering post (204), and near the back, just above the drive track (205) by other framing pieces (46, 52, 53, 220). The axle mounts are the notched circles used to mount bicycle wheels. In order to maximize tension between the drive rims (24) and the drive belts (34A, 34B), the notches face downwards and towards the middle of the frame (ie: the front mount faces downward and backward, the back mount faces downward and forward). The process of sliding the axles into the mounts thereby increases the distance between the axles, increasing the drive belt tension.

Each side frame (40) forms a triangle between the front axle (20), the rear axle (22), and a point higher than the topmost portion of the drive track and approximately midway between the two axles (203) (this position may vary). An additional piece of the frame (44) extends forward from near the lower front vertex (206), parallel to the lower side of the triangle, and is connected by a perpendicular piece (46) to the piece of frame (204) that surrounds the steering column (41). The piece around the steering column is also connected near its top to a longitudinal piece (48) that connects to three other bars below the seat (50). Two of these bars (53) each connect to one of the two side frames near their top vertices (203, 207). The third bar connects to a horizontal bar (52) that connects the two side frames at a point close to the drive track (205). In addition to adding structural strength, this horizontal bar prevents excessive snow buildup on the treads, protecting the components under the seat from jamming with snow. An additional brush may be added to this bar if necessary for adequate snow removal.

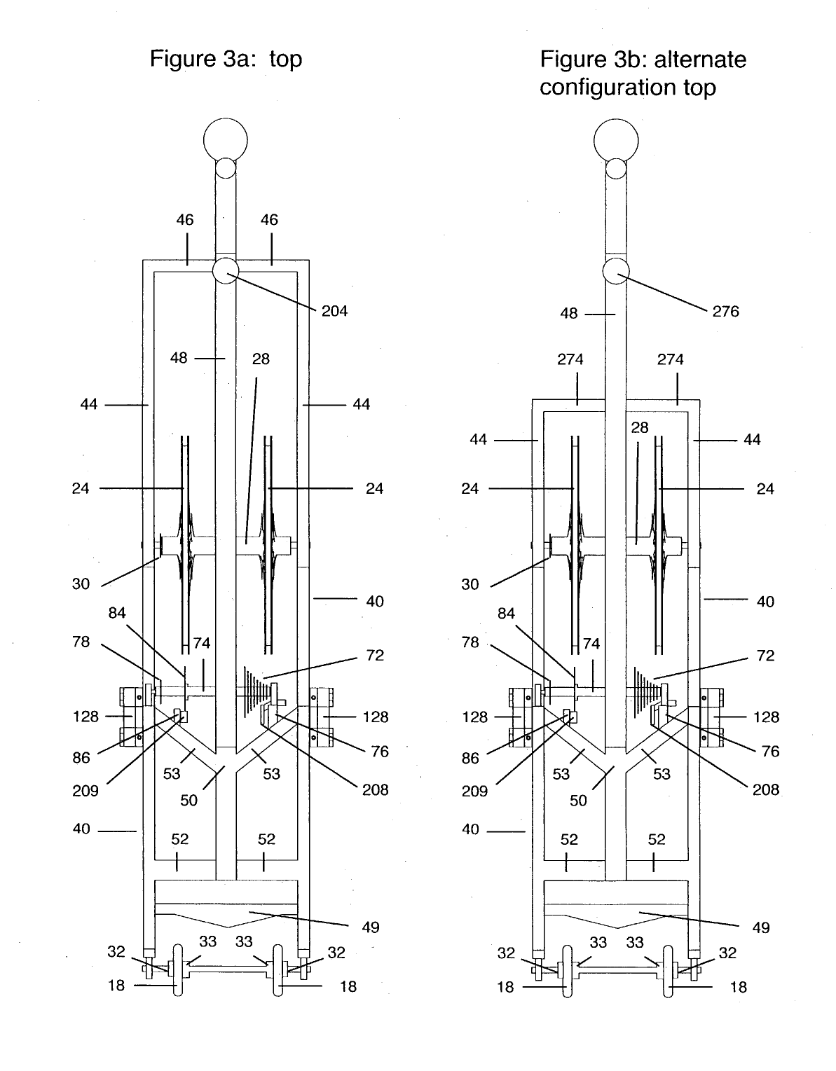

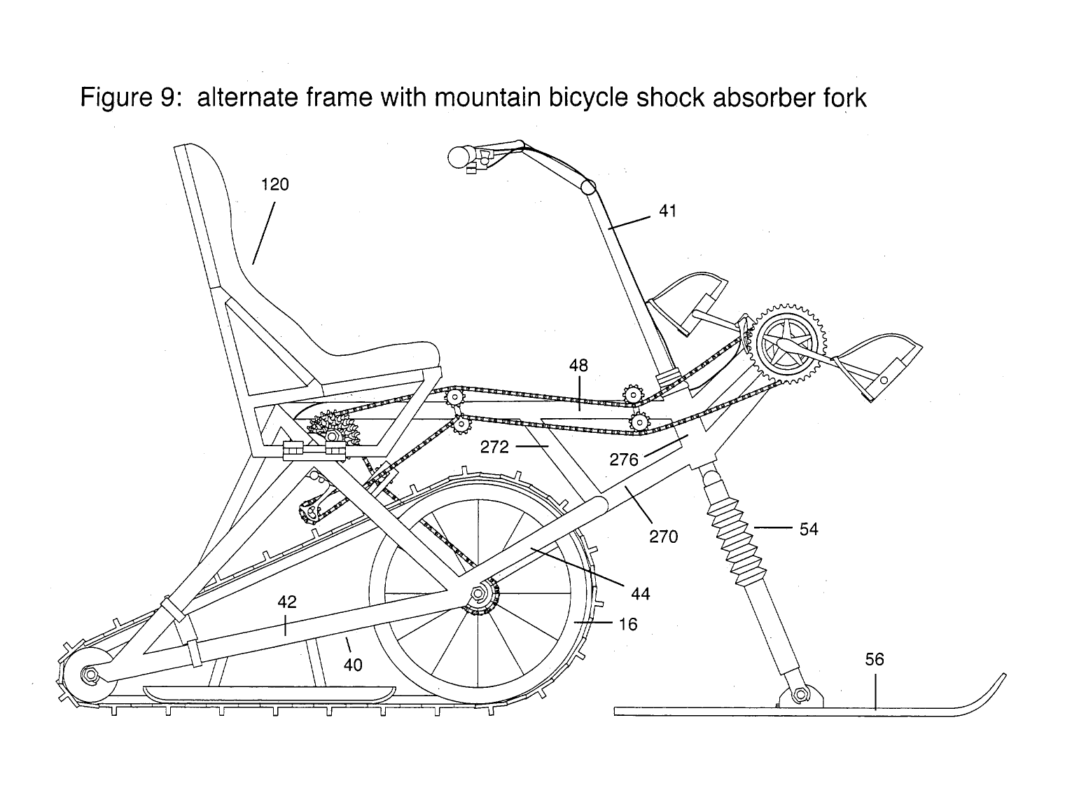

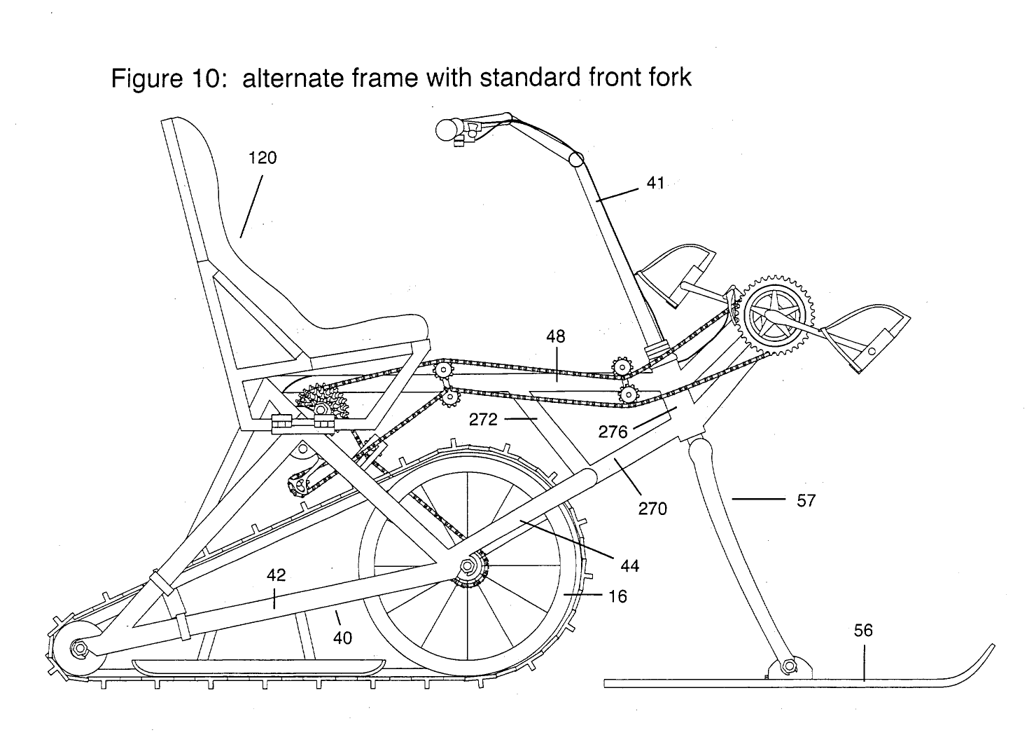

A variation (FIG. 3b, FIG. 9, FIG. 10) on this frame is also included in this patent. In this frame, the forward extending bars (44) from the side frames (40) project at an angle different from that of the base (42) of the side frame triangles and connect to one another through a perpendicular bar (274) just forward of and above the main drive wheels (16). A single bar (270) connects this perpendicular bar (274) to the steering column housing (276). This allows the steering column housing (276) to be the standard such piece found on a bicycle or mountain bike. A standard bicycle or mountain bike fork (57) or shock absorber (54) may be used as the steering column extending down to the ski (56). This may allow for lower costs by capitalizing on the larger front fork market. This adaptation may also increase strength over a single post between the ski (56) and steering column housing (276). Note that since the drive wheel (16) is of smaller diameter than a conventional upright bicycle wheel, the steering fork and ski mounts can be easily designed so that the use of a standard fork or shock absorber places the ski (56) at ground level. Another bar (272) increases frame strength by creating another trapezoid in the frame (frame between bars 48, 270, 272, 276). To prevent snow from building up between the drive belts (34A, 34B) and the drive wheel rims (24), a scraper and/or brush may be attached to the side frames so that it brushes snow from the downward facing belts before entering the drive rims. The scraper may be chevron shaped so that the forward moving snow is thrust outwards.

IV Power System

Power is supplied by the user's legs, though it may be supplemented by an electric motor. To accommodate the pedaling system, the frame extends forward of and above where it surrounds (204) the steering column (41). The front pedaling system is the standard gear and derailleur system found in the front position of other bicycles or mountain bikes. A small bar (64) extends upwards and backwards for mounting of the derailleur.

The chain (14) passes from the front gears (66) down and backwards underneath two toothed guide wheels (68) located on the top bar (48) of the frame just behind the steering column (41). It then passes above two similar wheels (70) close to the front of the seat and engages the rear gear system (72). The rear gear system (72) is located above the drive track and behind the front axle, giving enough vertical clearance so that the bottom of its derailleur does not touch the track or any snow on the track in any of the derailleur positions. As with the front gear system, the rear gear and derailleur system is compatible with existing rear derailleur systems for bicycles and mountain bikes.

The rear gears (72) drive a specialized hub (74). This hub rotates around an axle (213) that is attached to the left side of the frame (40) near the top vertex (207), and to a bar (76) protruding forward from the bar (53) connecting the right vertex (203) to the center bar (48, 218) under the seat (50). This protruding bar (76) has a fixture from which the rear derailleur (208) is mounted. The hub (74) covers most of the axle (213). Its interior is similar to the interior of rear bicycle wheel hubs, turning on ball bearings, and it is sealed against moisture entry.

The right side of the hub (74) is similar to the right side of bicycle drive wheel hubs, with an attachment for the rear gear system (72). These gears (72) drive the hub when turned forward, but allow the hub to spin forwards when the gear component is turned backwards or held still. The left side of the hub (74) is mounted with a fixed gear (78), a gear whose rotation is locked to that of the hub. A chain (80) passes around this gear, down around the fixed gear (30) on the left side of the drive wheel hub (28), and back. The chain (80), after it has already passed around the drive hub gear and is returning to the upper hub gear (30) when the vehicle is moving forwards, passes around a guide wheel (82) whose position can vary perpendicularly to the chain. This guide wheel (82) allows for easier installation and removal of the chain by allowing a longer chain to be used than would form a tight loop around the two gears. It can either have a spring that pushes it against the chain, or it can be manually adjusted and locked into the desired position with a screw or bolt.

The braking system works by slowing the upper hub (70), whose rotation is locked into that of the drive hub (28) by the chain (80) and fixed gears (78, 30) (the relation need not be a one to one rotational relationship since the gears may have different radii). A disk brake system (84) is used, with the disk affixed to a larger radius section of the upper hub (74). The brake mechanism (209) is mounted to a forward protruding bar (86) similar to that (76) to which the right side of the upper hub axle (213) is mounted, but closer to the center to allow space for the disk in front of the bar (53) connecting the center (50) to the left side frame (40). This braking system is at present more expensive than the other braking systems, so it is preferred that only one be used. This should be sufficient because of the reliability and stopping power of the upper end models of this product. However, if it proves necessary to have multiple braking systems, then the hub may be designed to accept two disks (84A, 84B). In this case, the inner disk (84B) will need to be mounted from the right, while the gears are not attached to the hub. An alternate braking system could apply friction to the drive rims as in more traditional braking systems; however, snow may impede the performance of such a system, and additional framing would be necessary to position the brakes behind the drive wheels, to locate them out of the way of the drive track. An optional emergency brake could use a simple lever that applies stopping friction to the drive track or that presses down into the snow. This lever could be hand or foot operated.

V Steering Ski

The steering ski (56) attaches to the steering column midway between the front (56A) and back (56B) of the ski at two points (92) near the its left and right sides. If the ski (56) omits a shock absorber, then the portion of the steering column below the frame may be very simple, forking near the bottom to attach to the outer sides of the ski bracket (92). Otherwise, this portion may be replaced with a bicycle fork, with (54) or without (57) shock absorbers, or a custom built shock absorber (FIG. 13) could be used.

The fork (57, 59, 54, 100) attaches to the ski bracket (92) with a standard bicycle axle (90), which may be secured using a quick release mechanism or with hex nuts or some other fastener. The axle passes through the ski brackets (92). These brackets (92) may be constructed similarly to a bicycle wheel hub so that the axle turns on ball bearings in housings sealed against moisture penetration. If a simpler solution, such as a hinge around a pin, will afford satisfactory pivoting of the ski despite harsh usage, then that may be used instead. In either case, the ski may be removed while the axle is attached to the ski.

A helical spring (94) surrounding the axle (90) presses against the ski (56) behind the mounting bracket (92) and against the lower portion of the fork (57, 59, 54, 100) (for which purpose, a horizontal bar (96) may be affixed to the fork just above the mounting bracket, or else the spring (94) may include a bar that pushes against the two times of the fork (57, 59, 54, 100)), keeping the tip of the ski (56A) pointing up when it leaves the ground. The spring (94) should be of sufficient strength so as to keep the tip of the airborne ski up even when surrounded with wet snow, but not so great as to cause excessive drag while under normal operation. The ends of the spring are each bent into a rectangle that presses against the fork (57, 59, 54, 100) and the ski (56), though the upper end may include a wider portion if the horizontal bar (96) is omitted from the fork.

The end of the spring that presses against the ski is secured under three ledges (98) prior to insertion of the axle (90) through the cylinder of the spring (94). The spring (94) is thereby kept securely in place even when the ski (56) is not attached to the fork (57, 59, 54, 100). A similar device may secure the spring to the fork or fork bar (96) so that the tip of the ski (56A) is kept at a single rest position when not pressed against the ground. The rest position should place the tip of the ski (56A) at an angle somewhere between horizontal and vertical (with the tip up), closer to horizontal likely being preferable.

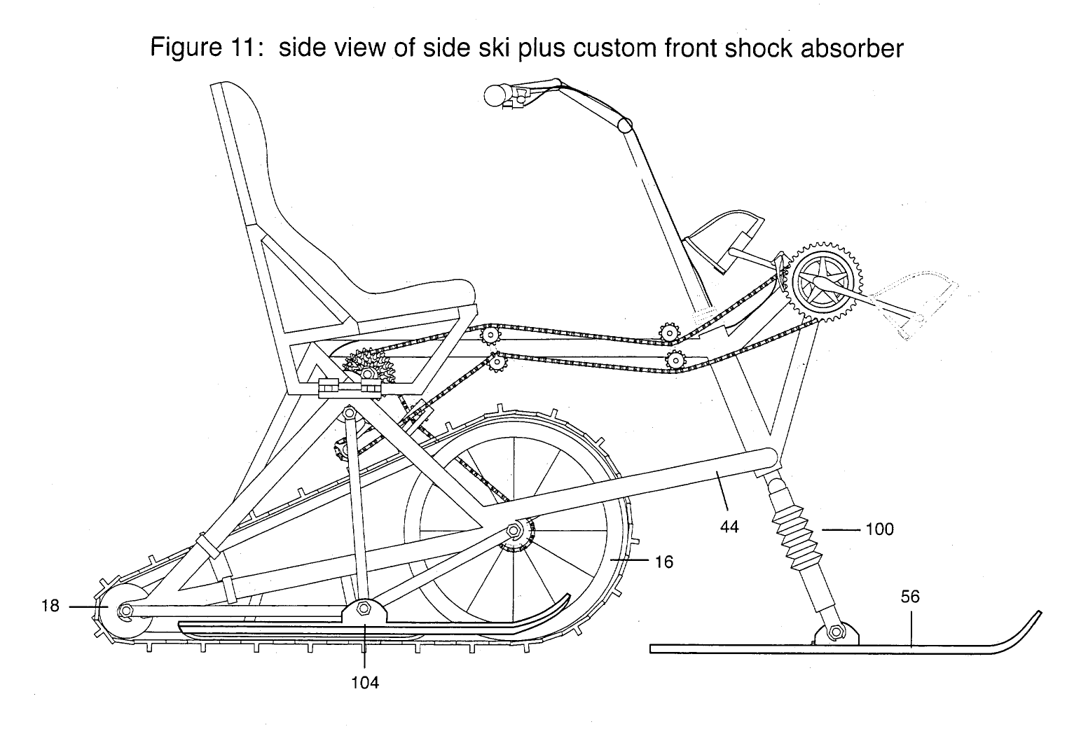

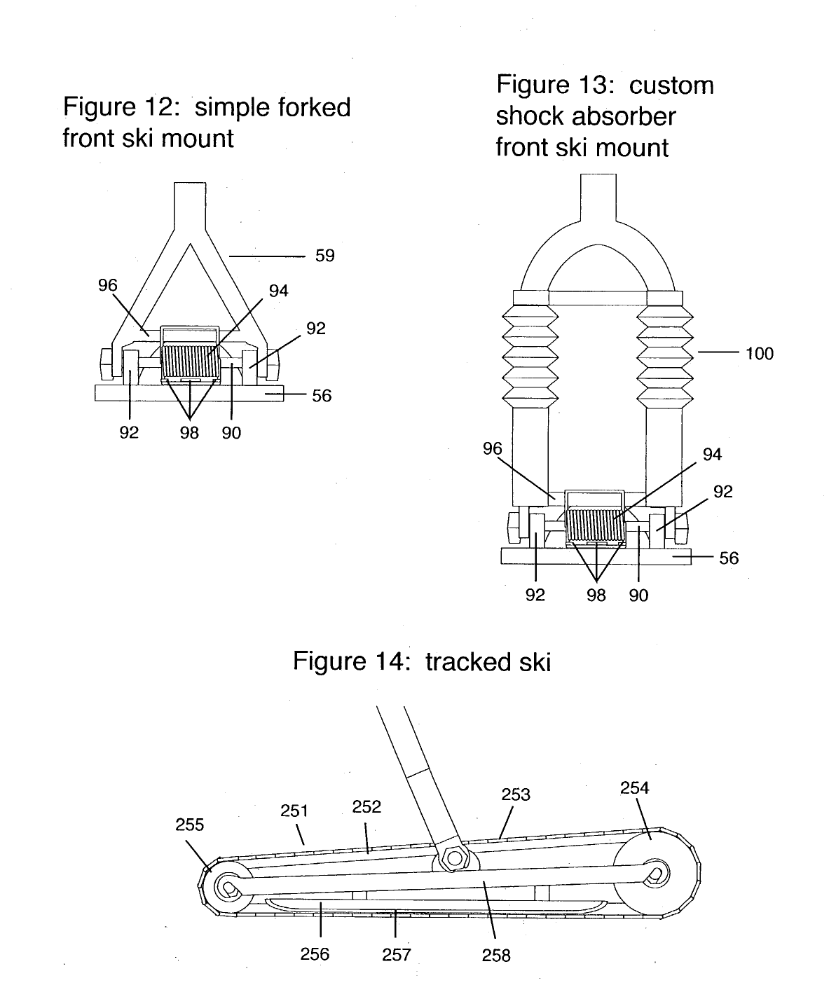

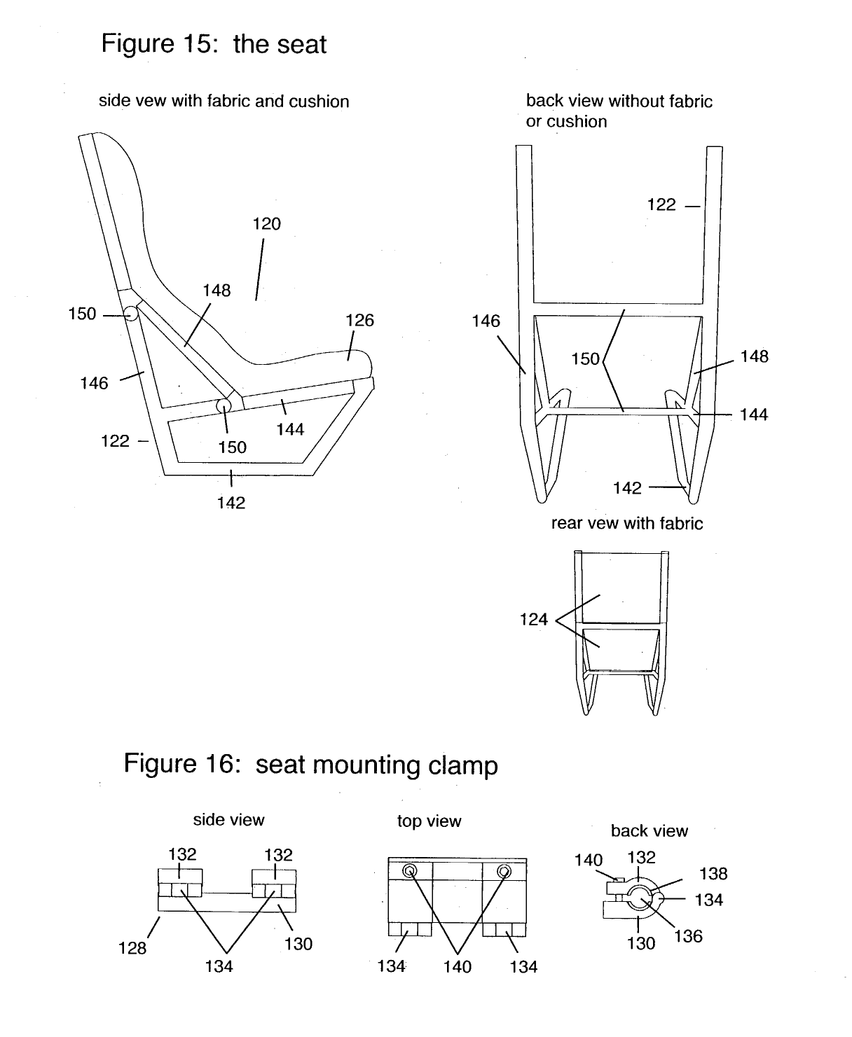

The fork may also be fitted with a shock absorber (54, 100), which might be desirable on rough, hard packed trails or in other situations. When used with the alternate frame (FIG. 9), mountain bicycle shocks (54) may be substituted for the standard bicycle fork (57). For use with the standard frame (FIG. 11), or if it proves desirable to produce a custom shock absorber (FIG. 13) (it may be shorter than conventional shock absorbers since it does not need to straddle a wheel), then the custom shock absorber (100) may be used. If a shock absorber can be produced that will turn the ski with only one compression unit, then this may also be used.

Without the shocks, the steering column housing (204) may extend lower for added strength, though this may be unnecessary or more expensive than using a longer front fork with less framing.

VI Side Skis

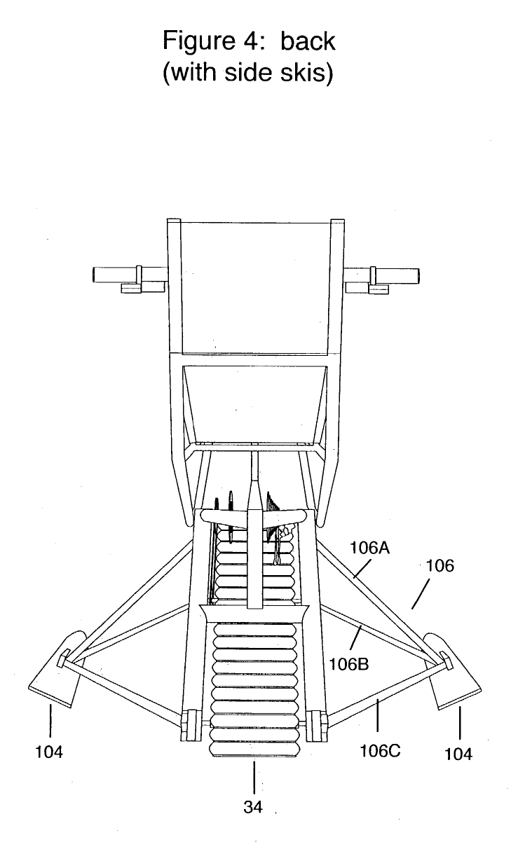

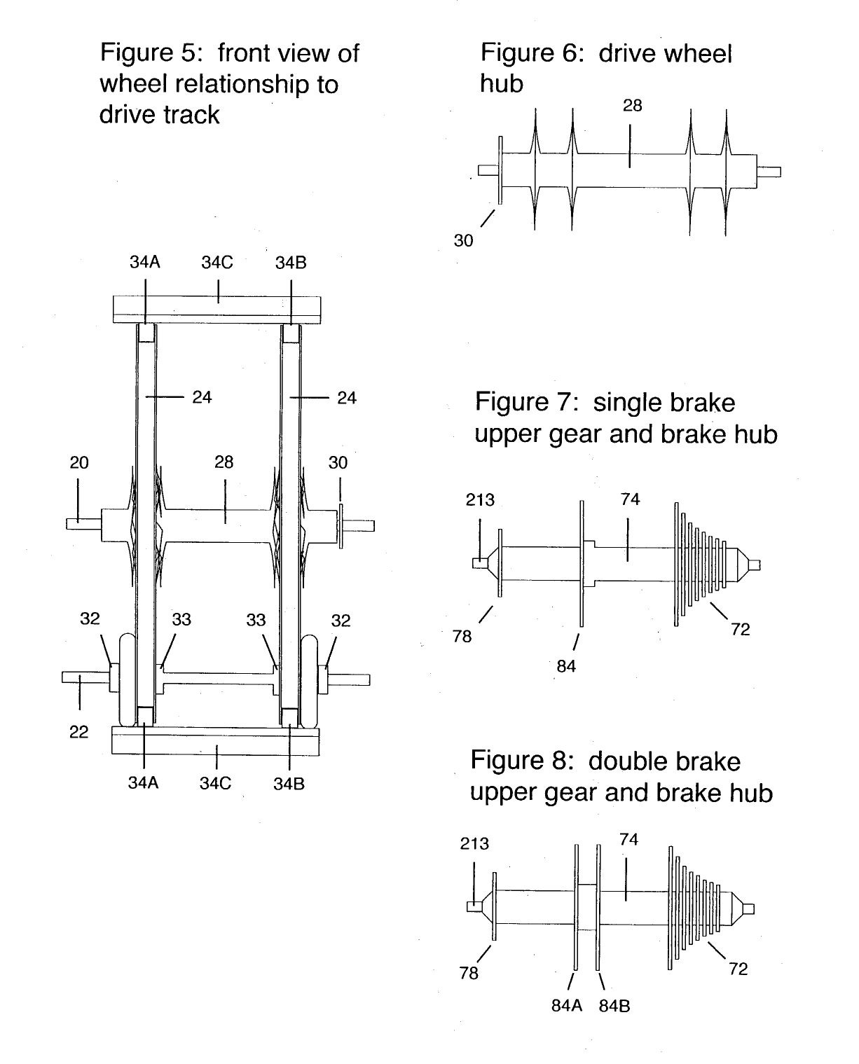

Side skis (104) can be attached to give added stability (FIG. 4). This may prove advantageous for novice users or in high speed turning (as in downhill use). The skis (104) may be mounted via a bracket (106) consisting of three bars. The top bar (106A) attaches to a flange (210) of metal within the top vertex (203, 207) of each side frame. The flange has a hole or holes to receive the ski bracket. The other two bars (106B, 106C) of the bracket may either be attached to the front (20) and rear (22) axles, or flanges similar to the one (210) in the top vertex may be added for this purpose.

The skis (104) should be slightly raised above the level of the center ski (56) and drive track (34) so that they do not increase friction during straight travel over smooth ground. They may be angled so that they are flush with the ground when the vehicle is tilted onto one of the skis on a flat surface. This may be altered so that the plane of the ski is parallel to the plane of the bottom of the drive track (34).

VII Tracked Steering Ski

In order to be useable on roads that may be in an uncertain state of snow cover, a tracked steering ski (FIG. 14) option is presented. The tracked ski consists of a continuous loop tread (251), much like the drive track, with continuous belts (252) connected by crossbars (253). The belts pass just inside of a front (254) and a rear (255) wheel, so that the wheels press against the cross bars (253) and the outer sides of the belts (252). Bars (256) with low friction strips (257), attached to the support bars (258) and in line with the wheels, prevent the tread from caving upward.

The ski may be secured with a quick release mechanism if it can be assured that it will not inadvertently open under pressure from snow or low plants protruding through the snow. Otherwise, a hex nut or other fastener may be used.

VIII Seat

The seat (120) here described is designed to adjust to various height users. This is especially important if this product is to be used by children, which is one of the potentially viable markets (since this product may be easier to learn than cross-country skiing and may offer more excitement with less of a learning curve). An adjustable seat allows multiple people to use the same vehicle and allows for longer term of service for growing children. If the mechanism here described proves to be structurally inadequate for long term use, then reinforcements may be added to the basic design or the cycle frame may be modified to accept another seat design. Even if the seat proves insufficiently strong for adult cyclists, it may still prove viable for children.

The seat (120) consists of a tubular metal frame (122) with fabric (124) stretched between the sides and an optional, formfitting cushion (126). The seat attaches to the vehicle frame by clamps (128) securely attached (as by welding) to the left and right outermost sides of the side frames, near the top vertices (203, 207). These clamps (128) have a solid bottom piece (130) and two upper pieces (132) connected to the bottom piece by hinges (134). When the upper pieces (132) are closed against the bottom piece (130), two cylindrical spaces are encircled (136) such that the bottom seat bars (142) can be secured within. A half cylinder of rubber (138) or other material lines both the top (132) and the bottom (130) pieces for increased grip on the bar (142). The top pieces are tightened and loosened with an alien screw (140) or a wing nut. The lowest part of the left and right sides of the chair (120) is a horizontal tube (142) parallel to the lengthwise orientation of the vehicle. This tube (142) is longer than the length of the clamp (128) so that it may be slid forward or back when the clamp is loosened; this allows for forward and backward adjustment of the seat position. The clamp (128) is long enough so that when its two top pieces (132) are securely fastened, the bottom chair tube (142) can withstand, when in any seat adjustment position, the forces and torque it will undergo during strenuous cycling.

If the seat (120) need be wider than the distance between the two clamps on the sides of the frame, then the tubing proceeds outward as it proceeds upward; otherwise, the tubing of each side of the seat frame remains in a single plane. The two sides of the seat consist of a tube (144) approximating the seated leg angle, a tube (146) approximating the seated angle of the upper back that meets this tube, a tube (148) approximating the seated angle of the lower back that is secured to the leg tube (144) and the upper back tube (146) (this adds strength in addition to matching the structure of the body), and tubing to connect the leg tube (144) and the upper back tube (146) to the tube secured by the clamp (142). The upper back tube (146) may pass down to the clamp and back up to the front of the leg tube, being bent instead of welded to limit the number of pipes used per side to three. Otherwise, the different segments may be welded; the final design should be selected by seeking maximum strength and cost effectiveness. The seat frame sides are connected with tubes (150) located just below and just behind where the lower back tube (148) connects to the upper back tube (146) and the leg tube (144) respectively.

Fabric (124) spans the side frames to support the legs, lower back, and upper back. A contoured cushion (126) may be secured to the seat for greater comfort and shock absorbency. The cushion (126) may be secured by fasteners passing underneath and behind the frame.

The back of the seat frame may also include a variety of mounting options for satchels or other carrying devices.

IX Steering Column

The steering column (41) is similar to that used in recumbent bicycles. It may include a securable hinge (211) to allow its elevation to be adjusted.

X Reverse Track Configuration

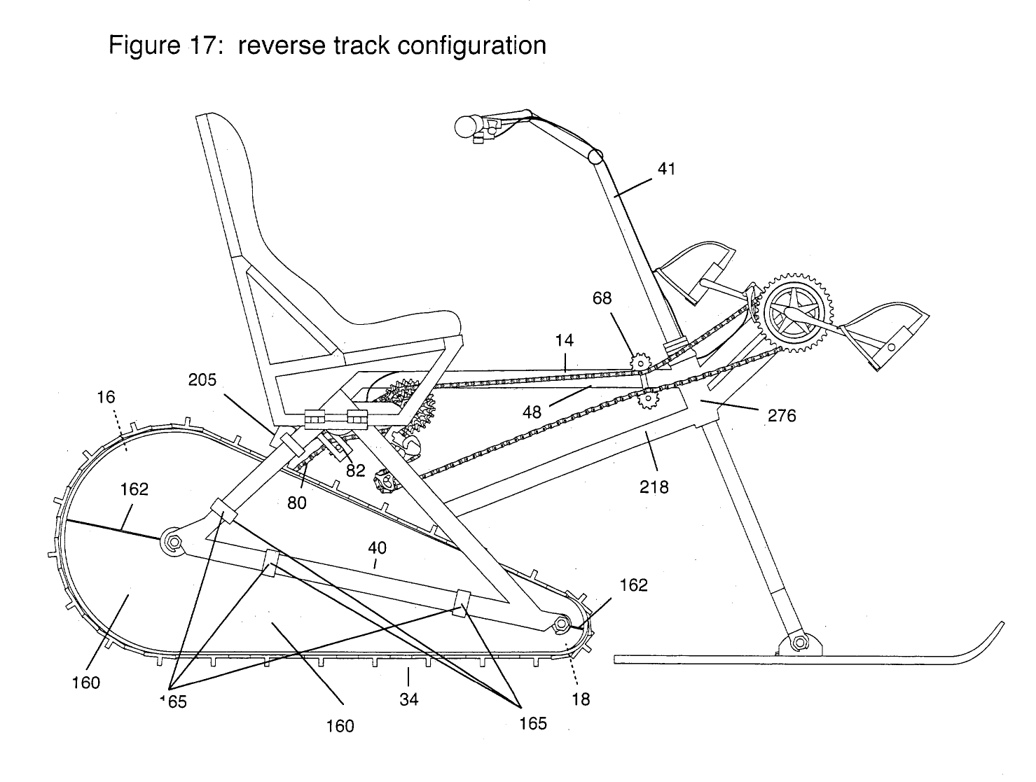

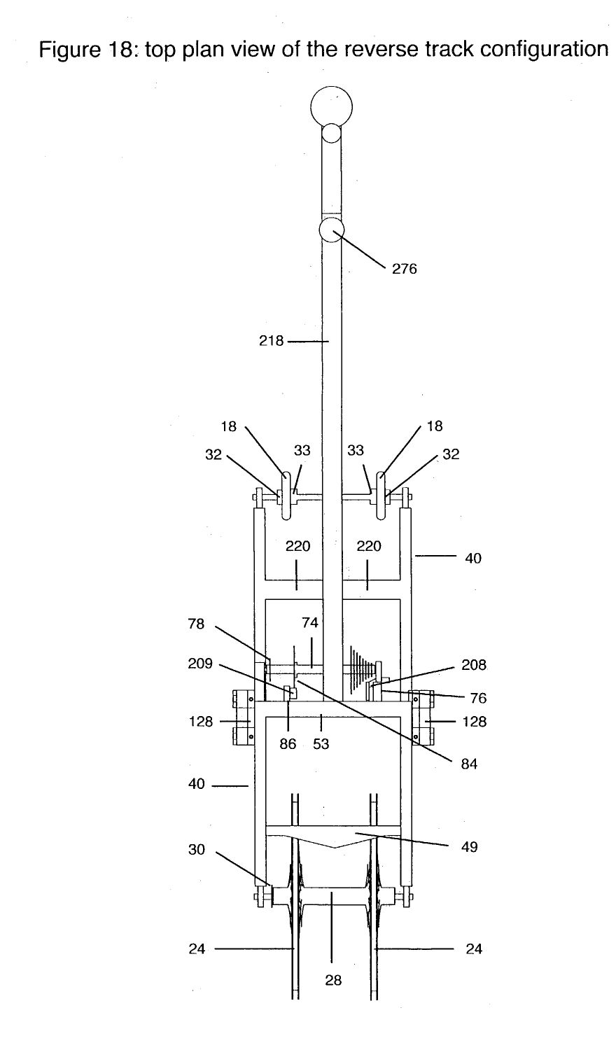

An alternative configuration (FIG. 17) is also presented for the snow vehicle. In this configuration, the drive wheels (16) and the small guide wheels (18) are reversed so that the large drive wheels (16) are in back. The frame changes correspondingly so that the side frames do not extend forward. Rather, the horizontal bar (220) connecting the two side frames (40) just above the drive track is connected to a longitudinal bar (218) that connects to the steering column housing (276).

The rear set of guide wheels (70) for the forward chain (14) is removed, and the bottom part of the forward chain (14) passes above its guide wheel (68) instead of below.

The advantages of this alternative include a shortened forward chain, a simpler frame, and the potential of greater drive power because the force from the drive wheel pulls directly on the part of the track in contact with snow instead of being redirected around the smaller wheels. A single shock absorber could also replace the lower frame bar (218) connecting the steering column housing (276) to the bar connecting the two side frames (220). In this case, the bars attached to the upper vertices (203, 207) of the side frames must be secured in a manner that allows the side frames to rotate. This modification may prove moderately useful in reducing jarring by small bumps.

The disadvantage of this alternative is that snow in the space surrounded by the drive tread should be kept to a minimum; otherwise, snow (especially wet snow) may build up between the drive belt and drive rims. A fabric covered frame (160) mounted to the side frames (40) on either side so that it covers the side openings might reduce snow entry enough to be viable. These covers have a channel (162) leading to an open circle (163A, 163B) for the drive hub and the front axle. Ribs (164) on the inner side of the covers, leading from the frame mounts (165) to these circles and the outer frame (166), give them a flexible form. This cover may be omitted if it proves to be unnecessary.

XI Drive Track Crosspiece

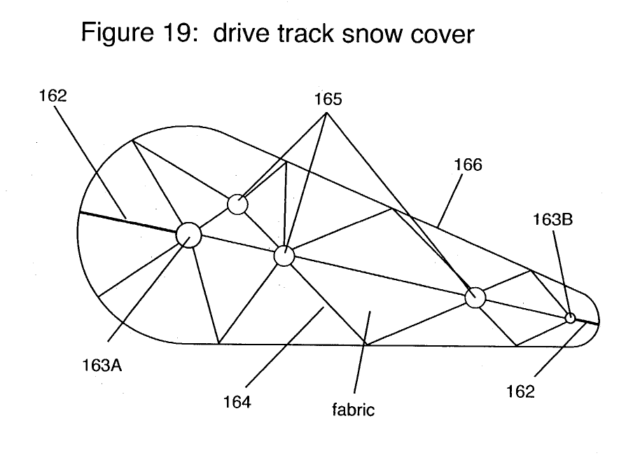

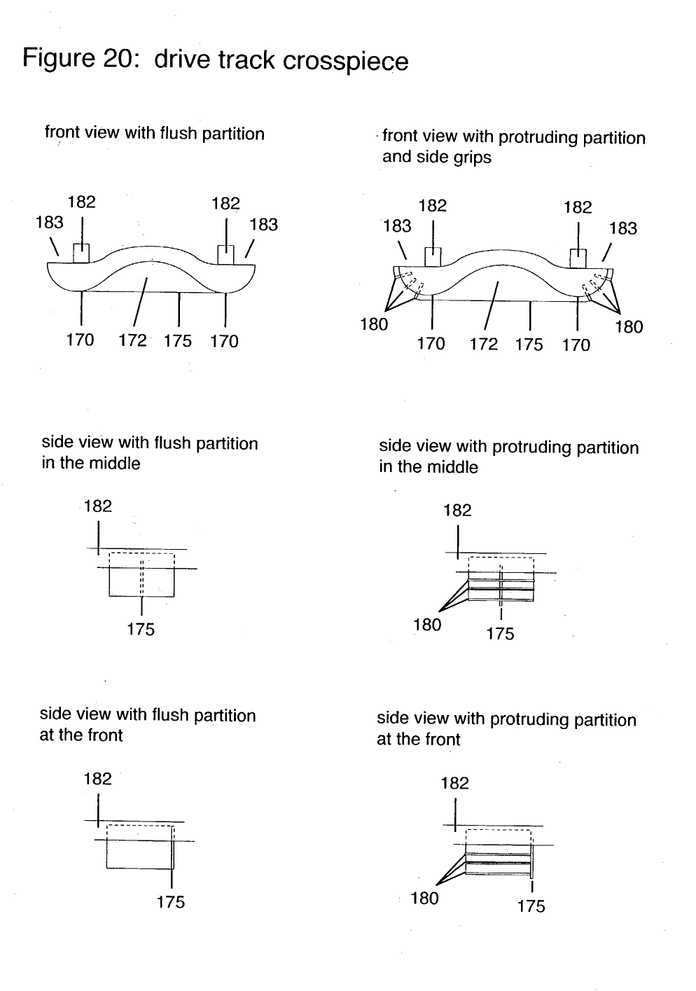

An improved drive track crosspiece (FIG. 19) may allow the vehicle to lean into a curve more easily while maintaining the stability and buoyancy afforded by a flat crossbar. This tread is convex at each side (170) and concave (172) in the middle. The convex parts (170) allow the vehicle to lean more easily. In loose snow, the snow is pushed away from the convex parts (170), some of which collects in the concave part (172), creating a more compact center to buoy the vehicle.

To increase traction, a thin, vertical partition (175) running parallel to the crosspiece and either in the middle (177) or at its front (178), cuts into loosely packed snow trapped in the concave (172) channel. The partition may also extend beyond (179) the main body of crosspiece for added traction on hard packed snow or ice while traveling straight or leaning into a turn.

Ridges (180) parallel to the direction of motion of the crosspiece, on the outer sides of the convex (170) parts, may protrude out from the crosspiece to prevent the vehicle from slipping laterally when leaning into a turn.

The drive belt (182) and space (183) for the guide wheels (18) function the same for this crosspiece as for the flat crosspiece.

XII Supply Toboggan

A supply toboggan should be attachable to the rear of the vehicle in such a way that it will not interfere overmuch with general operation and so that it will not swing out of the path of travel. It may attach either to the rear axle mount or to the frame itself. A mount or mounts may be included in the vehicle frame to allow for such attachment:

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention.

In the claims:

1. A human-powered, recumbent snowmobile, comprising:
(a) a frame,
(b) a steering column and a steering ski attached to the frame,
(c) a drive track attached to the frame,
(d) a drive system powering the drive track, the drive system powered by the rider's legs, and
(e) a recumbent seat attached to the frame.

2. The snowmobile of claim 1, wherein the drive track further comprises at least two continuous belts, and further comprising at least two front wheels and at least two rear wheels engaged by the continuous belts, the continuous belts having cross-pieces substantially perpendicular thereto.

3. The snowmobile of claim 2, wherein the at least two front wheels further comprise bicycle wheel rims attached by spokes to hubs rotating on ball bearings around an axle.

4. The snowmobile of claim 3, wherein the bicycle wheel rims further comprise a circular central portion sandwiched between a pair of circular peripheral portions of a diameter greater than the central portion, and a channel formed by the central portion and the peripheral portions, and wherein the continuous belt is frictionally engaged in the channel.

5. The snowmobile of claim 4, wherein the crosspieces extend laterally from the belts a distance equal to or greater than the distance between the rear wheels.

6. The snowmobile of claim 1, wherein the seat is adjustable for users of various heights.

7. The snowmobile of claim 6, wherein the seat is removably mounted to the frame by a clamp and wherein the seat may be slid forward or backward by loosening the clamp.

8. The snowmobile of claim 3, wherein the drive system further comprises a pair of pedals rotatably mounted to the frame, a front derailleur driven by the pedals, a chain extending rearwardly from the front derailleur, a rear derailleur engaging the chain, a rear hub driven by the rear derailleur, and a second chain engaging the rear hub and the front wheel hub.

9. The snowmobile of claim 8, wherein the rear derailleur is mounted to the frame above the drive track and behind the front axle, wherein the rear derailleur does not touch the drive track and any snow on the drive track in any position.

10. The snowmobile of claim 8, wherein the drive system further comprises an adjustable guide wheel engaging the second chain to adjust the tension of the second chain.

11. The snowmobile of claim 8, further comprising a disk brake engaging the rear hub.

12. The snowmobile of claim 2, further comprising a brake frictionally engaging the front wheels.

13. The snowmobile of claim 8, further comprising an emergency brake.

14. The snowmobile of claim 1, wherein the steering column further comprises a fork removably attached to the steering ski by a mounting bracket.

15. The snowmobile of claim 14, further comprising a spring pressing against the ski behind the mounting bracket to keep the tip of the ski pointing up when it leaves the ground.

16. The snowmobile of claim 14, wherein the steering column further comprises a shock absorber.

17. The snowmobile of claim 1, further comprising side skis attached to the frame.

18. The snowmobile of claim 1, wherein the steering ski further comprises a continuous track engaging the snow.

19. The snowmobile of claim 1, wherein the height of the steering column is adjustable.

20. The snowmobile of claim 2, wherein the at least two rear wheels further comprise bicycle wheel rims attached by spokes to hubs rotating on ball bearings around an axle.

21. The snowmobile of claim 20, wherein the bicycle wheel rims further comprise a circular central portion sandwiched between a pair of circular peripheral portions of a diameter greater than the central portion, and a channel formed by the central portion and the peripheral portions, and wherein the continuous belt is frictionally engaged in the channel.

22. The snowmobile of claim 21, further comprising a drive track cover preventing snow from entering the inside of the drive track.

23. The snowmobile of claim 2, wherein the crosspieces have ends and a middle therebetween, and wherein the ends are convex relative to the ground and the middle is concave relative to the ground.

24. The snowmobile of claim 23, further comprising a vertical partition engaging the crosspiece between the ends and parallel to the crosspiece.

25. The snowmobile of claim 23, further comprising ridges extending outwardly from the ends of the crosspiece.

26. The snowmobile of claim 1, further comprising a removable supply toboggan.

27. The snowmobile of claim 1, further comprising an engine providing additional power to the drive system.

28. A human-powered, recumbent snowmobile, comprising:
(a) a frame,
(b) a steering column and a steering ski attached to the frame,
(c) a drive track attached to the frame, wherein the drive track further comprises at least two continuous belts, and further comprising at least two front wheels and at least two rear wheels engaged by the continuous belts, the continuous belts having cross-pieces substantially perpendicular thereto, wherein the at least two front wheels further comprise bicycle wheel rims attached by spokes to hubs rotating on ball bearings around an axle,
(d) a drive system powering the drive track, the drive system powered by the rider's legs, and
(e) a recumbent seat attached to the frame.

29. The snowmobile of claim 28, wherein the bicycle wheel rims further comprise a circular central portion sandwiched between a pair of circular peripheral portions of a diameter greater than the central portion, and a channel formed by the central portion and the peripheral portions, and wherein the continuous belt is frictionally engaged in the channel.

30. A human-powered, recumbent snowmobile, comprising:
(a) a frame,
(b) a steering column and a steering ski attached to the frame,
(c) a drive track attached to the frame, wherein the drive track further comprises at least two continuous belts, and further comprising at least two front wheels and at least two rear wheels engaged by the continuous belts, the continuous belts having cross-pieces substantially perpendicular thereto, wherein the at least two front wheels further comprise bicycle wheel rims attached by spokes to hubs rotating on ball bearings around an axle, wherein the bicycle wheel rims further comprise a circular central portion sandwiched between a pair of circular peripheral portions of a diameter greater than the central portion, and a channel formed by the central portion and the peripheral portions, and wherein the continuous belt is frictionally engaged in the channel,
(d) a drive system powering the drive track, the drive system powered by the rider's legs, wherein the drive system further comprises a pair of pedals rotatably mounted to the frame, a front derailleur driven by the pedals, a chain extending rearwardly from the front derailleur, a rear derailleur engaging the chain, a rear hub driven by the rear derailleur, and a second chain engaging the rear hub and the front wheel hub, and
(e) a recumbent seat attached to the frame.

31. A human-powered, recumbent snowmobile, comprising:
(a) a frame,
(b) a steering column and a steering ski attached to the frame,
(c) a drive track attached to the frame, wherein the drive track further comprises at least two continuous belts, and further comprising at least two front wheels and at least two rear wheels engaged by the continuous belts, the continuous belts having cross-pieces substantially perpendicular thereto, wherein the at least two rear wheels further comprise bicycle wheel rims attached by spokes to hubs rotating on ball bearings around an axle,
(d) a drive system powering the drive track, the drive system powered by the rider's legs, and
(e) a recumbent seat attached to the frame.

32. The snowmobile of claim 31, wherein the bicycle wheel rims further comprise a circular central portion sandwiched between a pair of circular peripheral portions of a diameter greater than the central portion, and a channel formed by the central portion and the peripheral portions, and wherein the continuous belt is frictionally engaged in the channel.

33. A human-powered, recumbent snowmobile, comprising:
(a) a frame,
(b) a steering column and a steering ski attached to the frame,
(c) a drive track attached to the frame, wherein the drive track further comprises at least two continuous belts, and further comprising at least two front wheels and at least two rear wheels engaged by the continuous belts, the continuous belts having cross-pieces substantially perpendicular thereto, wherein the at least two rear wheels further comprise bicycle wheel rims attached by spokes to hubs rotating on ball bearings around an axle, wherein the bicycle wheel rims further comprise a circular central portion sandwiched between a pair of circular peripheral portions of a diameter greater than the central portion, and a channel formed by the central portion and the peripheral portions, and wherein the continuous belt is frictionally engaged in the channel,
(d) a drive system powering the drive track, the drive system powered by the rider's legs, wherein the drive system further comprises a pair of pedals rotatably mounted to the frame, a front derailleur driven by the pedals, a chain extending rearwardly from the front derailleur, a rear derailleur engaging the chain, a rear hub driven by the rear -derailleur, and a second chain engaging the rear hub and the rear wheel hub, and
(e) a recumbent seat attached to the frame.
